(19) United States
(12) Patent Application Publication
(10) Pub. No.: US 2026/0317920 A1
(43) Pub. Date: Oct. 15, 2026

(54) POROUS TRANSPORT LAYER, WATER ELECTROLYSIS CELL COMPRISING THE SAME, AND METHOD FOR MANUFACTURING THE POROUS TRANSPORT LAYER

(71) Applicants: Hyundai Motor Company, Seoul (KR); Kia Corporation, Seoul (KR); LT Metal Co., Ltd., Incheon (KR)

(72) Inventors: Soobin Yoon, Hwaseong (KR); Pil Young Lee, Hwaseong (KR); Youngjune Park, Hwaseong (KR); Yikyung Jeong, Seoul (KR); Hyeonjeong Jo, Seoul (KR); Jaegwan Shin, Asan (KR)

(21) Appl. No.: 19/304,750

(22) Filed: Aug. 20, 2025

(30) Foreign Application Priority Data
Apr. 10, 2025 (KR) 10-2025-0046507

(51) Int. Cl. C25B 11/032; C25B 9/23; C25B 11/036; C25B 11/037; C25B 11/052; C25B 11/063; C25B 11/081; C25D 3/50; C25D 7/06

(52) U.S. Cl. CPC C25B 11/032; C25B 9/23; C25B 11/036; C25B 11/037; C25B 11/052; C25B 11/063; C25B 11/081; C25D 3/50; C25D 7/0628

(57) ABSTRACT

The present disclosure relates to a porous transport layer, a water electrolysis cell including the same, and a method for manufacturing the porous transport layer. According to one aspect of the present disclosure, a porous transport layer including a porous substrate and a first coating layer disposed on one surface of the porous substrate and including platinum (Pt)-containing nanoparticles may be provided.

### CROSS-REFERENCE TO RELATED APPLICATION

This present application claims the benefit of Korean Patent Application No. 10-2025-0046507, filed on Apr. 10, 2025, in the Korean Intellectual Property Office, the entire disclosure of which is incorporated herein by reference.

### BACKGROUND

### Technical Field

The present disclosure relates to a porous transport layer, a water electrolysis cell comprising the same, and a method for manufacturing the porous transport layer.

### Background

A polymer electrolyte membrane water electrolysis (PEMWE) cell is an electrochemical conversion device that uses electricity to decompose water (H₂O) into hydrogen (H₂) and oxygen (O₂). The anode in the water electrolysis cell is subjected to harsh conditions such as high potential and an acidic environment. Since the anode potential of the water electrolysis cell is about 1.8 V or higher, it is greater than the corrosion potential of carbon, which is 0.207 V. Therefore, a porous transport layer (PTL) made of titanium is used at the anode instead of a conventional carbon-based gas diffusion layer (GDL).

The PTL is a key component that affects the performance and durability of the water electrolysis cell. The PTL uniformly distributes and/or diffuses the water as the reactant to the surface of the anode electrode, discharges oxygen generated at the anode electrode through a bipolar plate to the outside and collects and/or transfers electrons generated by electrochemical reaction. However, about 78% of the degradation factors in the water electrolysis cell are attributed to an increase in resistance occurring in the PTL. Therefore, research on PTL materials that can improve not only the performance but also the durability of the water electrolysis cell is needed.

The matters described in this Background section are only for enhancement of understanding of the background of the disclosure, and should not be taken as acknowledgement that they correspond to existing technologies already known to those skilled in the art.

### SUMMARY

The following summary presents a simplified summary of certain features. The summary is not an extensive overview and is not intended to identify key or critical elements.

The present disclosure is directed to providing a porous transport layer having improved electrical conductivity and durability, and a method for manufacturing the same.

The present disclosure is further directed to providing a water electrolysis cell having improved electrochemical performance and durability by including the porous transport layer.

The present disclosure is further directed to providing a manufacturing method capable of manufacturing the porous transport layer having improved performance in a simplified and cost-reduced manner.

Some embodiments of the present disclosure may provide a porous transport layer including a porous substrate, and a first coating layer disposed on one surface of the porous substrate and including platinum (Pt)-containing nanoparticles.

In some embodiments, the nanoparticles may have an average particle diameter of 0.1 nm to 100 nm.

In some embodiments, the first coating layer may have an average thickness of 0.03 μm to 1 μm.

In some embodiments, a surface of the first coating layer may include protrusions formed by the nanoparticles.

In some embodiments, the porous substrate may include a titanium group element.

In some embodiments, the porous transport layer may further include a second coating layer, the second coating layer being disposed on the other surface of the porous substrate, comprising platinum (Pt)-containing nanoparticles, and having a smaller average thickness than the first coating layer.

In some embodiments, the average thickness of the second coating layer may be about 1% to 99% of the average thickness of the first coating layer.

In some embodiments, the second coating layer may have an average thickness of 1 nm to 500 nm.

Some embodiments of the present disclosure may provide a water electrolysis cell including the porous transport layer.

In some embodiments, the water electrolysis cell may further include a membrane electrode assembly disposed on the first coating layer of the porous transport layer, and an anode bipolar plate disposed on a surface where the first coating layer is not located.

In some embodiments, the porous transport layer may further include a second coating layer, the second coating layer being disposed on the other surface of the porous substrate, the second coating layer comprising platinum (Pt)-containing nanoparticles and having a smaller average thickness than the first coating layer. The anode bipolar plate may be disposed on the second coating.

Some embodiments of the present disclosure may provide a method for manufacturing a porous transport layer, including arranging two porous substrates in parallel in a thickness direction, and forming a first coating layer including platinum (Pt)-containing nanoparticles on one surface of each porous substrate by electroplating.

In some embodiments, the first coating layer may be formed on a surface of each porous substrate opposite to a surface of the porous substrate that faces the other porous substrate.

In some embodiments, the two porous substrates may be arranged without a gap.

In some embodiments, the two porous substrates may be arranged spaced apart by a predetermined gap.

In some embodiments, the porous transport layer may further include a second coating layer formed on a surface of each porous substrate that faces the other porous substrate.

In some embodiments, the gap may be smaller than the average thickness of the porous substrate.

In some embodiments, the electroplating may use a plating solution comprising hydrogen hexachloroplatinate (IV) hydrate and sulfuric acid.

In some embodiments, the electroplating may be performed at a temperature of about 30° C. to 100° C.

The porous transport layer according to embodiments of the present disclosure may have improved electrical conductivity and durability.

Further, the present disclosure may provide a water electrolysis cell having improved electrochemical performance and durability by including the porous transport layer.

As discussed, the method and system suitably include use of a controller or processer.

In another embodiment, vehicles are provided that comprise an apparatus as disclosed herein.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a cross-sectional view of a porous transport layer according to some embodiments of the present disclosure.

FIG. 2 is a cross-sectional view of a porous transport layer according to some embodiments of the present disclosure.

FIG. 3 is a partial cross-sectional view of a water electrolysis cell according to some embodiments of the present disclosure.

FIG. 4 is a partial cross-sectional view of a water electrolysis cell according to some embodiments of the present disclosure.

FIG. 5A is a diagram showing a process for manufacturing a porous transport layer according to some embodiments of the present disclosure, and FIG. 5B is a cross-sectional view of a porous transport layer manufactured according to the process.

FIG. 6A is a diagram showing a process for manufacturing a porous transport layer according to some embodiments of the present disclosure, and FIG. 6B is a cross-sectional view of a porous transport layer manufactured according to the process.

FIG. 7 is a diagram showing an electroplating process of a porous transport layer according to some embodiments of the present disclosure.

FIG. 8 is a scanning electron microscope (SEM) image of a porous transport layer according to some embodiments of the present disclosure.

FIG. 9 shows results of platinum (Pt) distribution analysis using energy dispersive X-ray spectroscopy (EDS) for a porous transport layer according to some embodiments of the present disclosure.

FIG. 10 is a scanning electron microscope (SEM) image of a porous transport layer according to Comparative Example 3.

### DETAILED DESCRIPTION

Embodiments described in the present specification may be modified into various different forms, and the technology according to one implementation is not limited to the embodiments described below. The embodiments are provided to more completely explain the present disclosure to those having ordinary skill in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

Furthermore, terms including ordinals such as first, second, etc. may be used to describe various elements, but the elements are not limited by these terms. These terms are only used to distinguish one constituent element from another.

In the present disclosure, the average particle diameter means D50, and D50 means the diameter of particles corresponding to 50% of the cumulative distribution by volume. The average particle diameter can be derived from the particle size distribution results analyzed using MICROTRAC's S3500 by sampling the particles to be measured according to ISO 13320-1 standard.

The term “membrane electrode assembly” herein refers to an assembly comprising an electrolyte membrane interposed between an anode electrode layer and a cathode electrode layer, where the electrodes include catalyst layers facilitating the electrochemical reactions in water electrolysis.

The term “anode bipolar plate” herein refers to a conductive plate disposed adjacent to the anode side of the electrolyzer cell.

The term “protrusions” herein refers to the projections or stepped structures formed on the surface of the coating layer by non-uniform growth or aggregation of nanoparticles.

A porous transport layer may be positioned between an electrode layer of a membrane electrode assembly (MEA) and a bipolar plate. For example, the porous transport layer may be positioned between an anode electrode layer and an anode bipolar plate. For convenience, the following description is based on the case in which the porous transport layer is positioned between the anode electrode layer and the anode bipolar plate. However, the porous transport layer of the present disclosure may be equally applied between a cathode electrode layer and a cathode bipolar plate. This porous transport layer serves to transfer reactant water, generated oxygen gas, and electrons. The highest potential applied at the interface between the porous transport layer and the anode electrode layer may be up to 2.0 V. That is, the anode in the water electrolysis cell is exposed to a very harsh environment. Accordingly, coating a noble metal material such as platinum (Pt) on titanium material, which has excellent corrosion resistance even under harsh environments, has been proposed to suppress the oxidation reaction of titanium. However, when the water electrolysis cell is operated for an extended period, the coating layer such as platinum may become completely degraded and the titanium material may be oxidized, increasing the contact resistance of the porous transport layer, which in turn significantly reduces not only the performance but also the lifetime of the water electrolysis cell.

Therefore, research and development is needed for a porous transport layer that can maintain high electrical conductivity and durability even during prolonged operation of a water electrolysis cell.

Accordingly, after continued research, the inventors of the present disclosure found that platinum coating degrades more rapidly on the surface of the porous transport layer contacting the anode electrode layer than on the surface contacting the anode bipolar plate, and that metal-metal contact occurs between the metal coating layer of the anode bipolar plate and the platinum coating layer of the porous transport layer. This was confirmed to degrade the performance and durability of the water electrolysis cell. To address these issues, the inventors of the present disclosure conducted in-depth research and completed the present disclosure upon recognizing that a porous transport layer with remarkably improved electrical conductivity and durability may be obtained when a platinum-containing nanoparticle coating layer is formed on only one surface or is formed on both surfaces with different thicknesses.

Hereinafter, the present disclosure will be described in detail with reference to the accompanying drawings. However, this is merely exemplary, and the present disclosure is not limited to the specific embodiments described exemplarily.

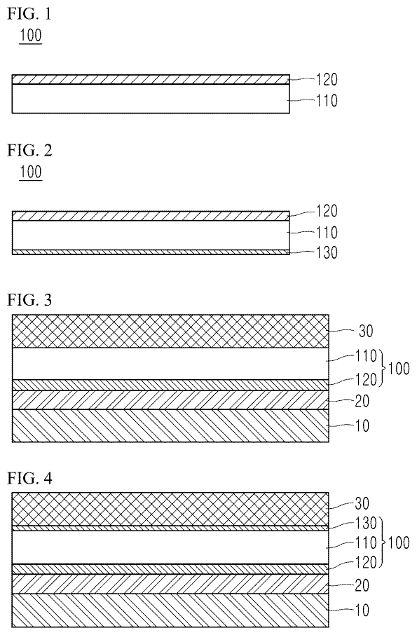

Referring to FIG. 1, a porous transport layer (100) according to one embodiment may include a porous substrate (110), and a first coating layer (120) positioned on one surface of the porous substrate (110) and comprising platinum (Pt)-containing nanoparticles.

By including the first coating layer (120) on one surface of the porous substrate (110), the porous transport layer (100) may have advantages of improved electrical conductivity and durability relative to the amount of platinum used. As the first coating layer (120) includes platinum-containing nanoparticles, a porous transport layer (100) with enhanced ion transfer efficiency and electrochemical reactivity may be provided due to an increased contact area between the porous transport layer (100) and the electrode. In addition, as the nanoparticle-containing first coating layer (120) is positioned on one surface of the porous substrate (110), a porous transport layer (100) with improved durability may be provided by effectively preventing metal oxidation reaction of the porous substrate (110).

In one embodiment, the nanoparticles may have an average particle diameter of 0.1 nm to 100 nm. When the average particle diameter of the nanoparticles is within this range, the nanoparticles may bond with each other to form a uniform coating layer while preventing exposure of metal elements of the porous substrate (110) on the surface. Accordingly, the porous transport layer (100) according to one embodiment may exhibit improved electrical conductivity and durability.

The shape of the nanoparticles is not limited, and may include particle shapes such as spherical, elliptical, plate-like, or irregular shapes.

In one embodiment, the nanoparticles may further include one or more of ruthenium (Ru), rhodium (Rh), palladium (Pd), osmium (Os), or iridium (Ir) in addition to platinum (Pt).

In one embodiment, the first coating layer (120) may have an average thickness of 0.03 μm to 5 μm, 0.03 μm to 2 μm, or 0.03 μm to 1 μm. When the average thickness is below this range, issues such as non-uniform coating thickness and growth of a metal oxide layer on the porous substrate may occur. When the thickness exceeds this range, the effect relative to coating layer thickness may be small, and the cost may become excessively high, thereby reducing economic efficiency.

To enhance performance relative to the amount of platinum used, the first coating layer (120) may have an average thickness of 0.03 μm to 1 μm. When the thickness is within this range, durability may be improved over a longer period.

In one embodiment, the porous transport layer (100) may include protrusions formed by nanoparticles on the surface of the first coating layer (120). The protrusions may be in the form of fine projections or stepped structures. By including the protrusions, the porous transport layer (100) may have an increased surface area and thus increased contact area with the electrode. Accordingly, the ion transfer efficiency and electrochemical reactivity of the porous transport layer (100) may be improved.

In one embodiment, the porous substrate (110) may include a titanium group element. As the porous substrate (110) includes a titanium group element, the porous transport layer (100) may have improved corrosion resistance and stability at high temperatures. The titanium group element may include at least one selected from the group consisting of titanium, zirconium, and hafnium. In various exemplary embodiments, the titanium group element may include titanium.

The titanium group element may be used without particular limitation so long as it is in a form usable in manufacturing the porous transport layer (100), and may have, for example, a particle form, mesh form, or fiber form. The particle form may include, for example, spherical, elliptical, or irregular shapes.

The particles of the titanium group element may have an average particle diameter of 10 μm to 80 μm, 25 μm to 45 μm, or 30 μm to 50 μm. When the average particle diameter of the titanium group element particles is within this range, the porous transport layer (100) may exhibit improved porosity, rigidity, and resistance characteristics.

In one embodiment, the porous substrate (110) may have an average thickness of 20 μm to 1,000 μm, 100 μm to 500 μm, or 200 μm to 400 μm. When the porous substrate (110) satisfies the above thickness range, the porous transport layer (100) may exhibit improved resistance characteristics, reactant and generated gas transfer properties, and durability.

Referring to FIG. 2, in one embodiment, the porous transport layer (100) may further include a second coating layer (130) positioned on the other surface of the porous substrate (110). The second coating layer (130) may include platinum (Pt)-containing nanoparticles. The second coating layer (130) may have a smaller average thickness than the first coating layer (120). By including the second coating layer (130) having a smaller average thickness than the first coating layer (120), the porous transport layer (100) may suppress surface oxidation of the porous substrate (110) and reduce electrical contact resistance. At the same time, contact with a metal layer of the bipolar plate may be reduced, thereby reducing friction and wear that may result from such contact and improving contact reliability.

In one embodiment, the second coating layer (130) may have an average thickness that is 1% to 99%, 1% to 95%, 1% to 90%, 1% to 80%, 5% to 80%, or 10% to 80% of the average thickness of the first coating layer (120), but this may be modified so long as it does not deviate from the scope of the present disclosure.

In one embodiment, the second coating layer (130) may have an average thickness of 1 nm to 500 nm, 1 nm to 300 nm, 1 nm to 200 nm, or 5 nm to 100 nm, but the average thickness is not particularly limited so long as it is smaller than the average thickness of the first coating layer (120).

Hereinafter, a water electrolysis cell according to one embodiment will be described.

The present disclosure may provide a water electrolysis cell comprising the above-described porous transport layer (100).

In one embodiment, the water electrolysis cell may further include a membrane electrode assembly positioned on the first coating layer (120) of the porous transport layer (100), and an anode bipolar plate (30) positioned on the surface where the first coating layer (120) is not located.

For example, when the second coating layer (130) is not present, the anode bipolar plate (30) may be positioned on the porous substrate (110), and when the second coating layer (130) is present, the anode bipolar plate (30) may be positioned on the second coating layer (130).

For example, the membrane electrode assembly may include an anode electrode layer (20), an electrolyte membrane (10), and a cathode electrode layer sequentially stacked, and the anode electrode layer (20) of the membrane electrode assembly may be positioned on the first coating layer (120) of the porous transport layer (100).

Referring to FIG. 3, a water electrolysis cell according to one embodiment may include an electrolyte membrane (10), an anode electrode layer (20) formed on the electrolyte membrane (10), the first coating layer (120) of the porous transport layer (100) formed on the anode electrode layer (20), the porous substrate (110) formed on the first coating layer (120), and the anode bipolar plate (30) formed on the porous transport layer (100). Although not shown in the figure, the water electrolysis cell may further include a cathode electrode layer, a cathode gas diffusion layer, and a cathode bipolar plate sequentially on the other surface of the electrolyte membrane (10).

Referring to FIG. 4, when the second coating layer (130) is included on the porous transport layer (100), the second coating layer (130) may be positioned between the porous substrate (110) and the anode bipolar plate (30).

Hereinafter, a method for manufacturing a porous transport layer (100) according to one embodiment will be described.

The present disclosure may provide a method for manufacturing a porous transport layer (100), including arranging two porous substrates (110) in parallel in a thickness direction, and forming a first coating layer (120) comprising platinum (Pt)-containing nanoparticles on one surface of each porous substrate (110) by electroplating.

The method for manufacturing a porous transport layer (100) according to one embodiment has advantages of improved mass productivity and low cost compared to existing electroplating methods or other coating methods by forming the first coating layer (120) through electroplating with two porous substrates (110) arranged in parallel in the thickness direction. As an example of other coating methods, dry coating methods such as physical vapor deposition (PVD) or chemical vapor deposition (CVD) require a high vacuum environment and result in a high loss rate of noble metal during coating, thereby increasing process costs. In addition, coating layers formed by PVD or CVD methods do not include metal nanoparticles on the surface, and do not include protrusions such as projection-type or stepped structures composed of such nanoparticles. Accordingly, coating layers formed by PVD or CVD methods have relatively smooth and uniform surfaces but may increase contact resistance due to increased exposure area of titanium-based elements of the porous transport layer. When an oxide layer forms on a surface composed of exposed titanium-based elements, cell performance and long-term durability may be degraded. Meanwhile, spray coating methods may have disadvantages of a high noble metal loss rate during coating and high non-uniformity of the resulting coating layer.

The porous transport layer (100) intended by the present disclosure may be easily manufactured by adjusting the gap between the porous substrates (110). The porous transport layer (100) manufactured using such a method may have the first coating layer (120) formed on one surface of the porous substrate (110), or may have nanoparticle-containing coating layers of different thicknesses on both surfaces, and accordingly may exhibit remarkably improved electrical conductivity and durability relative to the amount of platinum used. In addition, platinum-containing nanoparticles may be coated on the porous substrate (110) with a uniform thickness using this manufacturing method, enabling production of a high-quality porous transport layer (100).

In one embodiment, the two porous substrates (110) may be fixed in parallel in a thickness direction by alligator clips or non-conductive fixing devices. The non-conductive fixing device may be, for example, a clamp or spacer made of a non-conductive polymer material. The alligator clips or non-conductive fixing devices may arrange the two porous substrates (110) in parallel while preventing electrical short circuit.

In one embodiment, the first coating layer (120) may be formed on one surface of each porous substrate (110). In various exemplary embodiments, the first coating layer (120) may be formed on a surface of each porous substrate (110) opposite to a surface of the porous substrate (110) that faces the other porous substrate (110).

In one embodiment, the porous transport layer (100) manufactured according to the method may further include a second coating layer (130) formed on one surface of each porous substrate (110). In various exemplary embodiments, the second coating layer (130) may be formed on a surface of each porous substrate (110) that faces the other porous substrate (110).

According to one embodiment of the manufacturing method, by arranging the two porous substrates (110) without a gap or spaced apart by a predetermined gap, high-quality platinum-containing nanoparticle coating layers may be formed on one surface of each porous substrate (110) or on both surfaces with different thicknesses.

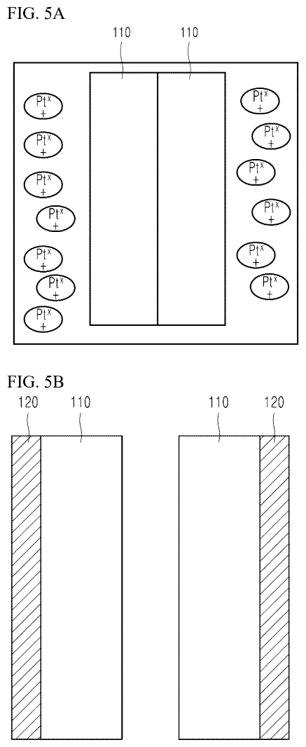

FIG. 5A is a diagram showing a manufacturing process of a porous transport layer according to one embodiment, and FIG. 5B is a cross-sectional view of a porous transport layer manufactured according to the process. Referring to FIGS. 5A and 5B, to manufacture a porous transport layer (100) according to this embodiment, two porous substrates (110) may be arranged without a gap, and with this configuration, a porous transport layer (100) with the first coating layer (120) formed only on one surface of each porous substrate (110) may be manufactured.

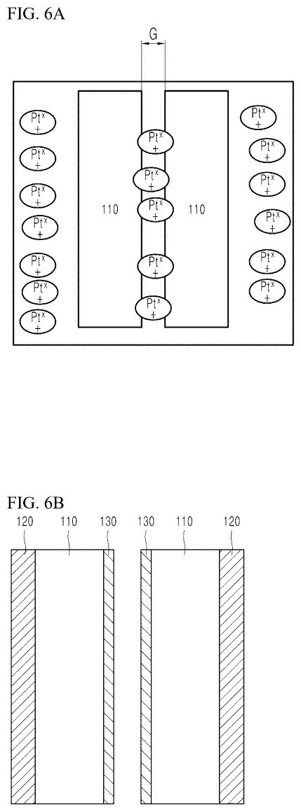

FIG. 6A is a diagram showing a manufacturing process of a porous transport layer according to another embodiment, and FIG. 6B is a cross-sectional view of a porous transport layer manufactured according to the process. Referring to FIGS. 6A and 6B, to manufacture a porous transport layer (100) according to this embodiment, two porous substrates (110) may be arranged spaced apart by a predetermined gap (G), and with this configuration, a porous transport layer (100) with the first coating layer (120) formed on one surface and the second coating layer (130) formed on the other surface of each porous substrate (110) may be manufactured.

The gap (G) may be smaller than the average thickness of the porous substrate (110). For example, the gap (G) may be 1% to 99%, 1% to 95%, 1% to 90%, 1% to 80%, 5% to 80%, 10% to 80%, or 10% to 50% of the average thickness of the porous substrate (110), but this may be modified so long as it does not deviate from the scope of the present disclosure.

For forming the first coating layer (120), known electroplating techniques in the relevant field may be used without limitation. For example, the electroplating may be performed by connecting the porous substrate (110), which is the coating target material, to the cathode and connecting platinum (Pt), which is the coating material, to the anode. As another example, the electroplating may be performed using a plating solution containing platinum (Pt) ions. The method using the plating solution is preferred in terms of mass productivity, but the method is not limited thereto so long as it does not deviate from the purpose of the present disclosure.

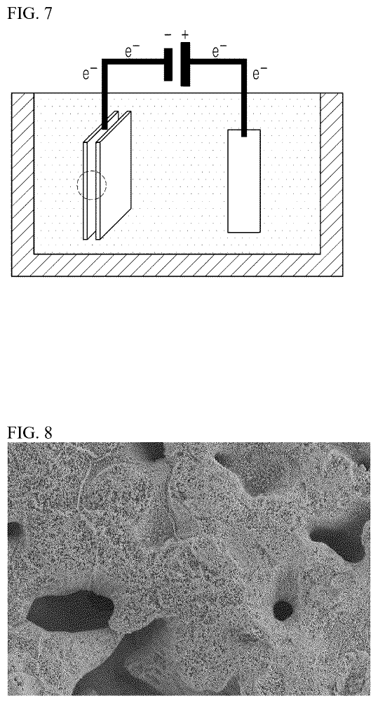

Referring to FIG. 7, the electroplating may be performed by immersing two parallel-arranged porous substrates (110) connected to the cathode, and an insoluble electrode connected to the anode, in a plating solution containing platinum (Pt) ions.

For example, the plating solution may include one or more selected from the group consisting of platinum(IV) chloride (PtCl₄), hydrogen hexachloroplatinate(IV) hydrate (H₂PtCl₆), hydrogen hexahydroxyplatinate (H₂Pt(OH)₆), chloroplatinic acid hydrate ((PtCl₆)(H₂O)ₓ (0≤x≤6)), and platinum acetylacetonate (Pt(CH₃COCHCOCH₃)₂).

As the solvent for the plating solution, water, alcohol, acid, base, or an organic solvent may be used, but the solvent is not particularly limited thereto.

The platinum (Pt) ions in the plating solution may be included at a concentration of 0.1 g/L to 5 g/L or 0.5 g/L to 3 g/L, but the concentration is not particularly limited thereto so long as the porous transport layer (100) intended by the present disclosure can be manufactured.

The plating solution may be acidic, and for example, the pH value of the plating solution may be 1 to 4. For example, the plating solution may include one or more selected from the group consisting of sulfuric acid (H₂SO₄), nitric acid (HNO₃), and hydrochloric acid (HCl).

For example, the plating solution may include hydrogen hexachloroplatinate(IV) hydrate (H₂PtCl₆) and sulfuric acid (H₂SO₄).

The electroplating may be performed at a temperature of 30° C. to 100° C. or 40° C. to 80° C.

The electroplating may be performed for 3 minutes to 60 minutes, 3 minutes to 30 minutes, or 5 minutes to 30 minutes.

The electroplating may be performed under a current density of 10 mA/cm² to 80 mA/cm², 10 mA/cm² to 50 mA/cm², or 20 mA/cm² to 40 mA/cm². Alternatively, the electroplating may be performed by applying a potential of 1.0 V to 5.0 V or 1.5 V to 5.0 V.

The temperature, time, current density, and potential for performing the above-described electroplating may be modified so long as they do not deviate from the scope of the present disclosure and are therefore not particularly limited to the above-described ranges.

Hereinafter, embodiments of the present disclosure are further described with reference to specific experimental examples. The examples and comparative examples included in the experimental examples are merely illustrative of the present disclosure and are not intended to limit the scope of the appended claims. It will be apparent to those skilled in the art that various changes and modifications to the embodiments may be made without departing from the scope and technical spirit of the present disclosure, and such changes and modifications are naturally intended to fall within the scope of the appended claims.

### Example 1

Two porous substrates with an average thickness of 150 μm were manufactured by a tape casting process from titanium particles having an average particle diameter (D50) of 35 μm. The two manufactured substrates were arranged in parallel in the thickness direction without a gap and were fixed with alligator clips. Pt electroplating was performed on the two fixed porous substrates as shown in FIG. 7 to manufacture a porous transport layer. The electroplating was conducted in an aqueous solution containing 2.0 g/L of hydrogen hexachloroplatinate(IV) hydrate (H₂PtCl₆) and 0.5 M sulfuric acid (H₂SO₄) at 60° C. for 10 minutes under a current density of 30 mA/cm², with the fixed two porous substrates connected to the cathode and an insoluble titanium plate connected to the anode. At this time, the first coating layer was formed on the exposed surface of each porous substrate. After removing the alligator clips, each porous substrate on which the first coating layer had been formed was washed with deionized water and dried at room temperature.

A scanning electron microscope (SEM) image of the manufactured porous transport layer surface is shown in FIG. 8. Referring to FIG. 8, platinum particles were uniformly coated on the porous substrate, and the platinum particles were clearly observed on the coated surface. In particular, protrusions formed by non-uniform growth of platinum particles were observed on portions of the coated surface. These protrusions appeared in the form of fine projections or stepped structures.

The average thickness of the coating layer was measured using X-ray fluorescence (XRF) equipment and is recorded in Table 1 below.

### Example 2

A porous transport layer was manufactured in the same manner as in Example 1, except that the electroplating was conducted for 15 minutes under a current density of 35 mA/cm² instead of for 10 minutes under a current density of 30 mA/cm².

The average thickness of the coating layer was measured using X-ray fluorescence (XRF) equipment and is recorded in Table 1 below.

### Examples 3 and 4

Porous transport layers were manufactured in the same manner as in Example 1, except that the gap between two porous substrates was adjusted using a clamp, with the gap values shown in Table 1 below.

FIG. 9 shows the results of analyzing platinum (Pt) distribution using energy dispersive X-ray spectroscopy (EDS) based on a cross-sectional SEM image of the porous transport layer manufactured according to Example 3. Referring to FIG. 9, it can be seen that arranging two porous substrates with a predetermined gap during electroplating resulted in a thicker coating layer being formed on one surface of the porous transport layer and a thinner coating layer being formed on the other surface. Hereinafter, the coating layer formed on a surface of each porous substrate that is opposite to a surface of the porous substrate that faces the other porous substrate (i.e., the opposite (outer) surface) during electroplating is referred to as a first coating layer, and the coating layer formed on the surface that faces the other porous substrate is referred to as a second coating layer.

The thicknesses of the first coating layer and the second coating layer formed on the porous transport layers of Examples 3 and 4 were measured using X-ray fluorescence (XRF) equipment and are recorded in Table 1 below.

### Comparative Example 1

A porous transport layer was manufactured in the same manner as in Example 1, except that electroplating was performed using only one porous substrate. Platinum coating layers were formed on both surfaces of the porous substrate, and the thickness of each layer is recorded in Table 1.

### Comparative Example 2

A porous transport layer was manufactured in the same manner as in Example 1, except that the gap between two porous substrates was adjusted with a clamp, with the gap values shown in Table 1 below. Platinum coating layers were formed on both surfaces of the porous substrate, and the thickness of each layer is recorded in Table 1.

### Comparative Example 3

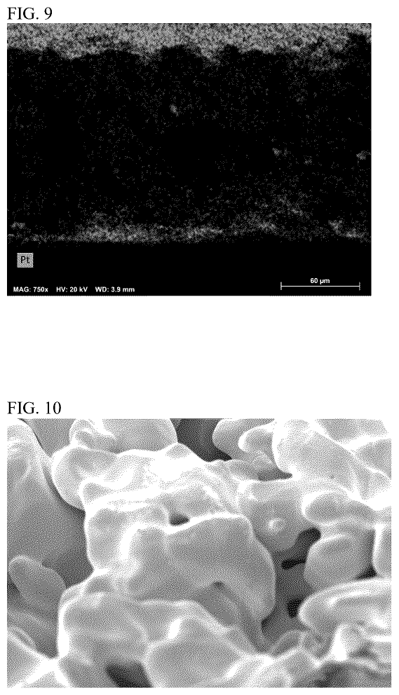

A porous substrate with an average thickness of 150 μm was manufactured by a tape casting process using titanium particles with an average particle diameter (D50) of 35 μm. Then, a coating layer was formed on one surface of the substrate by physical vapor deposition of platinum (Pt) to manufacture a porous transport layer. A platinum coating layer was formed on one surface of the porous substrate, and the thickness of the coating layer is recorded in Table 1. An SEM image of the manufactured porous transport layer surface is shown in FIG. 10. Referring to FIG. 10, although a platinum coating layer was formed on the porous substrate, unlike Example 1, the coating was continuous and uniform, and platinum particles were not observed on the coated surface. In addition, no protrusions, such as fine projections or stepped structures, were observed.

TABLE 1

| | Substrate | First Coating Layer | Second Coating |
|---|---|---|---|
| | Gap [μm] | Thickness [μm] | Layer Thickness [μm] |
| Example 1 | 0 | 0.1 | 0 |
| Example 2 | 0 | 1.0 | 0 |
| Example 3 | 20 | 0.1 | 0.02 |
| Example 4 | 60 | 0.1 | 0.06 |
| Comparative | — | 0.1 | 0.1 |
| Example 1 | | | |
| Comparative | 400 | 0.1 | 0.1 |
| Example 2 | | | |
| Comparative | — | 0.1 | — |
| Example 3 | | | |

Contact resistance was measured using contact resistance measurement equipment on the porous diffusion layers of Examples 1 to 4 and Comparative Examples 1 and 2, and the results are recorded in Table 2 below.

Additionally, the porous transport layers of Examples 1 to 4 and Comparative Examples 1 and 2 were cut to 5 cm×5 cm (width×length) and then assembled into water electrolysis cells configured to include an iridium (Ir) catalyst as the anode electrode layer, a carbon-supported platinum (Pt/C) catalyst as the cathode electrode layer, and Nafion 115 as the electrolyte membrane. The performance and durability of the water electrolysis cells were then evaluated by the following method. Specifically, the cells were assembled such that the surface having the first coating layer of the porous transport layer was positioned on the anode electrode layer and the second coating layer or porous substrate was positioned on the anode bipolar plate.

For cell performance evaluation, water was supplied at a flow rate of 0.2 LPM using a metering pump through a pure water supply line to the anode electrode layer side, and the voltage was measured while increasing the current density by 0.5 A/cm² per minute. The voltage at a current density of 2.0 A/cm² is recorded in Table 2.

Additionally, for cell durability evaluation, constant current evaluation was conducted at 2.0 A/cm² for 500 hours. Based on this, the voltage change rate per hour was calculated and is recorded in Table 2.

TABLE 2

| | Contact | | Voltage Change |
|---|---|---|---|
| | Resistance | Voltage (@ 2.0 | Rate per Hour (@ |
| | [mΩ · cm²] | A/cm²) [V] | 2.0 A/cm²) [+μV/hr] |
| Example 1 | 17.3 | 1.83 | 18.2 |
| Example 2 | 15.8 | 1.83 | 17.8 |
| Example 3 | 14.3 | 1.83 | 16.2 |
| Example 4 | 14.9 | 1.83 | 16.6 |
| Comparative | 12.9 | 1.83 | 15.3 |
| Example 1 | | | |
| Comparative | 13.3 | 1.83 | 15.6 |
| Example 2 | | | |
| Comparative | 18.1 | 1.84 | 19.6 |
| Example 3 | | | |

As can be seen from Table 2, the porous transport layers of Examples 1 to 4, which have platinum-containing nanoparticle coating layers on one surface or on both surfaces with different thicknesses, exhibited low contact resistance. Additionally, water electrolysis cells applying the porous transport layers of Examples 1 to 4 showed equivalent or improved electrochemical performance and remarkably improved durability. These results are comparable to those of Comparative Examples 1 and 2, in which coating layers of the same thickness are formed on both surfaces of the porous substrate. This indicates that the porous transport layers according to the embodiments can achieve comparable or better electrochemical performance and durability even while using a smaller amount of platinum-containing nanoparticle coating layers, thus offering potential for cost reduction through reduced platinum usage.

Although the porous transport layer of Comparative Example 3 has a coating layer on one surface of the porous substrate, it does not include platinum nanoparticles and protrusions formed therefrom in the formed coating layer, which is expected to decrease surface area and contact area with the electrode. Accordingly, the porous transport layer of Comparative Example 3 had higher contact resistance compared to the examples, and the water electrolysis cell applying the porous transport layer of Comparative Example 3 showed decreased durability.

The foregoing description is merely illustrative of an application of the principles of the present disclosure. Other configurations may also be included without departing from the scope of the present disclosure.

What is claimed is:

1. A porous transport layer comprising:
a porous substrate; and
a first coating layer disposed on one surface of the porous substrate and comprising platinum (Pt)-containing nanoparticles.

2. The porous transport layer of claim 1, wherein the nanoparticles have an average particle diameter of about 0.1 nm to 100 nm.

3. The porous transport layer of claim 1, wherein the first coating layer has an average thickness of about 0.03 μm to 1 μm.

4. The porous transport layer of claim 1, wherein a surface of the first coating layer comprises protrusions formed by the nanoparticles.

5. The porous transport layer of claim 1, wherein the porous substrate comprises a titanium group element.

6. The porous transport layer of claim 1, further comprising a second coating layer, the second coating layer being disposed on the other surface of the porous substrate, comprising platinum (Pt)-containing nanoparticles, and having a smaller average thickness than the first coating layer.

7. The porous transport layer of claim 6, wherein the average thickness of the second coating layer is about 1% to 99% of the average thickness of the first coating layer.

8. The porous transport layer of claim 6, wherein the second coating layer has an average thickness of 1 nm to 500 nm.

9. The porous transport layer of claim 1, wherein the porous substrate has an average thickness of 20 μm to 1,000 μm.

10. A water electrolysis cell comprising the porous transport layer of claim 1.

11. The water electrolysis cell of claim 10, further comprising:
a membrane electrode assembly disposed on the first coating layer of the porous transport layer; and
an anode bipolar plate disposed on a surface where the first coating layer is not disposed.

12. The water electrolysis cell of claim 11, wherein the porous transport layer further comprises a second coating layer, the second coating layer being disposed on the other surface of the porous substrate, the second coating layer comprising platinum (Pt)-containing nanoparticles and having a smaller average thickness than the first coating layer, and wherein the anode bipolar plate is disposed on the second coating.

13. A method for manufacturing a porous transport layer, the method comprising:
arranging two porous substrates in parallel in a thickness direction; and
forming a first coating layer comprising platinum (Pt)-containing nanoparticles on one surface of each porous substrate by electroplating.

14. The method of claim 13, wherein the first coating layer is formed on a surface of each porous substrate opposite to a surface of the porous substrate that faces the other porous substrate.

15. The method of claim 13, wherein the two porous substrates are arranged without a gap.

16. The method of claim 13, wherein the two porous substrates are arranged spaced apart by a predetermined gap.

17. The method of claim 16, wherein the porous transport layer further comprises a second coating layer formed on a surface of each porous substrate that faces the other porous substrate.

18. The method of claim 16, wherein the gap is smaller than an average thickness of the porous substrate.

19. The method of claim 13, wherein the electroplating uses a plating solution comprising hydrogen hexachloroplatinate (IV) hydrate and sulfuric acid.

20. The method of claim 13, wherein the electroplating is performed at a temperature of about 30° C. to 100° C.
